(19) United States
(12) Patent Application Publication
(10) Pub. No.: US 2025/0360893 A1
(43) Pub. Date: Nov. 27, 2025

(54) WIPER-BLADE INCLUDING TEXTURED SURFACE

(71) Applicant: Donald W. Westbrook, Carmel Valley, CA (US)

(72) Inventor: Donald W. Westbrook, Carmel Valley, CA (US)

(21) Appl. No.: 19/219,817

(22) Filed: May 27, 2025

Related U.S. Application Data
(60) Provisional application No. 63/651,779, filed on May 24, 2024.

(51) Int. Cl. B60S 1/38

(52) U.S. Cl. CPC B60S 1/3848; B60S 2001/3837; B60S 2001/3898

(57) ABSTRACT

A wiper blade includes: an elongated elastomeric body having an axial length, the body including a base and a blade projecting from the base, wherein the blade includes a blade edge on the opposite side of the body from the base; and a first set of scrubbing elements forming a first array located on a first side surface of the blade, wherein the first set of scrubbing elements includes a first plurality of scrubbing elements and a second plurality of scrubbing elements, wherein each of the first plurality of scrubbing elements is located closer to the blade edge as measured perpendicular to the axial length of the body than each of the second plurality of scrubbing elements, wherein each of the first plurality of scrubbing elements protrude a shorter height from the side surface of the blade than each of the second plurality of scrubbing elements.

### BACKGROUND OF THE INVENTION

Windshield wipers are an important safety feature on automobiles, trucks, motorcycles, buses, trains, and any other vehicle that includes a glass or polymeric windshield and is subject to rain, snow, ice, insects, tree sap, dirt, mud, and the like. Windshield wipers typically include a longitudinal frame and one or more flexible blade edges or squeegees running along the length of the frame. The frame is usually held by a motorized arm that sweeps the wiper across the windshield with the squeegee in contact with the windshield surface in order to sweep away rain, snow, and other debris so that the driver has a clear view in front of their vehicle.

Wiper blades for cleaning glass and polymeric surfaces on vehicles are known in highly varied configurations. Conventional wiper blades include one or more wiper blades manufactured from a flexible rubber material and joined to a wiper blade body, which in turn joins to a vehicles' wiper arm.

To improve performance, wiper blades may employ additional elements to assist removing debris from the windshield. One such design comprises a plurality of scrubbing elements configured along the wiper blade edge to engage the surface of the windshield during the cleaning motion. For example, the scrubbing configuration may include a number of rows of scrubbers that engage with and impinge on debris during the wiping motion. An example of such a wiper blade is taught in U.S. Pat. No. 7,735,184 B2, the entirety of which is incorporated herein by reference. However, even these specially designed windshield wipers sometimes fail to completely remove the ice, dirt, insects, and other debris from the windshield, which may obscure the driver's view.

Performance of a wiper blade may further depend on the attack angle the blade takes with respect to the windshield. FIG. 1 illustrates an attack angle that is too large (i.e., too steep) and FIG. 2 illustrates an attack angle that is too small (i.e., too shallow). When the attack angle is too steep, the windshield wiper blade may experience chattering, which contributes to incomplete wiping. When the attack angle is too shallow, the windshield wiper blade may again experience chattering, in part due to a lack of pressure against the windshield and may further have a difficult time pivoting at the time of direction change of the wiping motion. In contrast, the attack angle illustrated in FIG. 3 is within the range of 30 to 50 degrees, which is a preferred range for the angle of attack. An attack angle that is either too steep or too shallow further contributes to incomplete wiping, which prevents the wiper blades from completely removing the ice, dirt, insects, and other debris from the windshield, which may obscure the driver's view.

The attack angle is a function of various factors, including the alignment of the blade, the flexibility of the blade material, and other design and configuration attributes of the blade. For example, the typical material used for windshield wiper blades provides limited flexibility such that only a small portion of the blade surface contacts the windshield surface during the wiping motion. It is important for the alignment of blade and the other design and configuration attributes of the blade to appropriately compensate for the limited flexibility of the blade material. Accordingly, even at the appropriate attack angle, if the other factors are not optimized, debris may remain on the wiping surface through the wiping process.

Therefore, there is a need for a windshield wiper whose configuration more effectively facilitates debris removal from a windshield.

### BRIEF SUMMARY OF THE INVENTION

To meet the needs described above and others, the present disclosure provides a windshield wiper configured to more effectively remove debris from a windshield. Specifically, the present disclosure provides a wiper blade including a plurality of scrubbing elements located various distances from the edge of the wiper blade, wherein the height of the scrubbing elements increases as the distance from the edge of the blade increases. As a result, a greater area of the wiper blade may remain in contact with the windshield during the wiping motion, increasing the engagement of the scrubbing elements with debris on the windshield, improving the performance of the blade and removing a greater amount of debris from the windshield.

In an embodiment, a wiper blade includes an elongated body having a base, a blade, a blade edge, and a plurality of scrubbing elements located along the blade at varying distances from the blade edge. The height of the scrubbing elements, which is a measurement of the distance the scrubbing element projects laterally from the blade, varies depending on the distance of the scrubbing element from the blade edge. In a preferred embodiment, the further the scrubbing element is from the blade edge, the greater its height. In one example, the blade has a first side surface, a second side surface, and a first row and a second row of scrubbing elements protruding from the blade on each of the first side surface and the second side surface. In this embodiment, the first row of scrubbing elements is closest to the blade edge than the second row of scrubbing elements and the scrubbing elements in the first row of scrubbing elements are taller (i.e., a greater height) than the scrubbing elements in the second row of scrubbing elements.

In another embodiment, a pair of wiper blades are joined in a single support structure such that they are configured in a parallel orientation to each other, with a channel formed between the two wiper blades. In this configuration, it may be preferable for each of the two wiper blades to include scrubbing elements on the exterior facing side of the wiper blade and for each wiper blade to have smooth (i.e., flat) interior facing sides. In this configuration, the two blade faces that are in most direct contact with the windshield include the scrubbing elements.

In yet another embodiment, a pair of wiper blades are joined in a single support structure such that they are configured in a parallel orientation to each other, with a channel formed between the two wiper blades. In this example embodiment, each of the two wiper blades includes scrubbing elements on the interior and exterior facing sides of the wiper blade.

According to the teachings provided herein, a wiper blade may include: an elongated elastomeric body having an axial length, the body including a base and a blade projecting from the base, wherein the blade includes a blade edge on the opposite side of the body from the base; and a first set of scrubbing elements forming a first array located on a first side surface of the blade, wherein the first set of scrubbing elements includes a first plurality of scrubbing elements and a second plurality of scrubbing elements, wherein each of the first plurality of scrubbing elements is located closer to the blade edge as measured perpendicular to the axial length of the body than each of the second plurality of scrubbing elements, wherein each of the first plurality of scrubbing elements protrude a shorter height from the side surface of the blade than each of the second plurality of scrubbing elements.

The first set of scrubbing elements may further include a third plurality of scrubbing elements, wherein each of the second plurality of scrubbing elements is located closer to the blade edge as measured perpendicular to the axial length of the body than each of the third plurality of scrubbing elements, wherein each of the second plurality of scrubbing elements protrude a shorter height from the first side surface of the blade than each of the third plurality of scrubbing elements.

The wiper blade may further include a second set of scrubbing elements forming a second array located on a second side surface of the blade, wherein each of a fourth plurality of scrubbing elements in the second set are located closer to the blade edge as measured perpendicular to the axial length of the body than a fifth plurality of scrubbing elements in the second set. In addition, the first set of scrubbing elements may further include a third plurality of scrubbing elements, wherein each of the second plurality of scrubbing elements is located closer to the blade edge as measured perpendicular to the axial length of the body than each of the third plurality of scrubbing elements, wherein each of the second plurality of scrubbing elements protrude a shorter height from the first side surface of the blade than each of the third plurality of scrubbing elements; and further wherein the second set of scrubbing elements further comprises a sixth plurality of scrubbing elements, wherein each of the fifth plurality of scrubbing elements is located closer to the blade edge as measured perpendicular to the axial length of the body than each of the sixth plurality of scrubbing elements, wherein each of the fifth plurality of scrubbing elements protrude a shorter height from the first side surface of the blade than each of the sixth plurality of scrubbing elements.

The first plurality of scrubbing elements may form a first row along the axial length of the body and the second plurality of scrubbing elements may form a second row along the axial length of the body, wherein the first row is closer to the blade edge than the second row.

Each scrubbing element may include: a substantially triangular cross-sectional shape; a substantially square cross-sectional shape; a substantially diamond cross-sectional shape; a substantially trapezoidal cross-sectional shape; a substantially hexagonal cross-sectional shape; and/or a tapered portion in which the tapered portion faces the blade edge.

Each scrubbing element may include a three-dimensional pyramid shape. The three-dimensional pyramid shape may be symmetrical or asymmetrical. For example, a first set of scrubbing elements may include a plurality of scrubbing elements comprising a first three-dimensional shape and a plurality of scrubbing elements comprising a second three-dimensional shape. The first three-dimensional shape may approximate a pyramid shape in which a tip of the pyramid is offset from a center of the base away from the blade edge and towards a side of the trapezoidal base furthest from the blade edge and the second three-dimensional shape may approximate a symmetrical pyramid shape having a square base.

The plurality of scrubbing elements may be discreet scrubbing elements that are independent and non-continuous along an axial length of the blade.

The scrubbing elements may be integrally molded with the blade. Alternatively, the scrubbing elements may be attached to the blade using an adhesive, a heat bonding technique, or similar attachment technique or process.

According to the teachings provided herein, a wiper blade assembly may include: a first wiper blade and a second wiper blade, each including: an elongated elastomeric body having an axial length, the body including a base and a blade projecting from the base, wherein the blade includes a blade edge on the opposite side of the body from the base; and a first set of scrubbing elements forming a first array located on a first side surface of the blade, wherein the first set of scrubbing elements includes a first plurality of scrubbing elements and a second plurality of scrubbing elements, wherein each of the first plurality of scrubbing elements is located closer to the blade edge as measured perpendicular to the axial length of the body than each of the second plurality of scrubbing elements, wherein each of the first plurality of scrubbing elements protrude a shorter height from the side surface of the blade than each of the second plurality of scrubbing elements; and a support engaging the base of the first wiper blade and the base of the second wiper blade such that the support holds the first wiper blade and second wiper in a fixed position relative to each other forming a longitudinal channel between the first wiper blade and the second wiper blade.

The wiper blade assembly may be provided such that the first side surface of the blade of the first wiper blade faces away from the second wiper blade and the first side surface of the blade of the second wiper blade faces away from the first wiper blade.

The wiper blade assembly may be provided such that each of the first wiper blade and the second wiper blade further comprise a second side surface of the blade, wherein the second side surface of each of the first wiper blade and the second wiper blade is a substantially smooth surface.

The wiper blade assembly may be provided such that the first plurality of scrubbing elements forms a first row along the axial length of the body and the second plurality of scrubbing elements forms a second row along the axial length of the body, wherein the first row is closer to the blade edge than the second row.

The wiper blade assembly may be provided such that the plurality of scrubbing elements are discreet scrubbing elements that are independent and non-continuous along an axial length of the blade.

The wiper blade assembly may be provided such that each scrubbing element comprises a shape including a tapered portion in which the tapered portion faces the blade edge.

The wiper blade assembly may be provided such that the first set of scrubbing elements includes a plurality of scrubbing elements comprising a first three-dimensional shape and a plurality of scrubbing elements comprising a second three-dimensional shape, further wherein the first three-dimensional shape approximates a pyramid shape in which a tip of the pyramid is offset from a center of the base away from the blade edge and towards a side of the trapezoidal base furthest from the blade edge and the second three-dimensional shape approximates a symmetrical pyramid shape having a square base.

An object of the subject matter disclosed herein is to provide a windshield wiper blade whose configuration more effectively facilitates debris removal from a windshield.

Another object of the subject matter disclosed herein is to improve the performance of windshield wiper blades that incorporate scrubbing elements.

Another object of the subject matter disclosed herein is to provide a scrubbing element configuration that enables a windshield wiper blade to more consistently maintain an attack angle within a preferred range.

Additional objects, advantages, and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a cross-sectional view of a prior art wiper blade with too steep of an attack angle with respect to a windshield.

FIG. 2 is a cross-sectional view of a prior art wiper blade with too shallow of an attack angle with respect to the windshield.

FIG. 3 is a cross-sectional view of a prior art wiper blade with an angle of attack within a preferred range of 30 to 50 degrees with respect to the windshield.

FIG. 4 is a perspective view of a wiper blade assembly embodying the disclosures provided herein in use with an automobile.

FIG. 5 is a perspective view of a wiper blade assembly including a wiper blade embodying the disclosures provided herein.

FIG. 6 is a close-up perspective view of one end of the wiper blade assembly of FIG. 5.

FIG. 7 is a cross-sectional view of the wiper blade assembly of FIG. 5.

FIG. 8 is a cross-sectional view of an alternative embodiment of a wiper blade assembly embodying the disclosures provided herein.

FIG. 9 is a cross-sectional view of another alternative embodiment of a wiper blade assembly embodying the disclosures provided herein.

FIG. 10 is a side view of an example of wiper blade assembly using the scrubbing elements from the wiper blades in FIGS. 5-9.

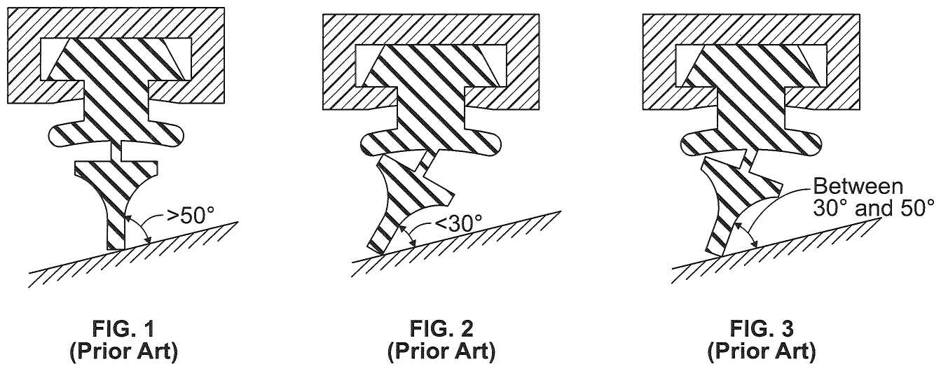

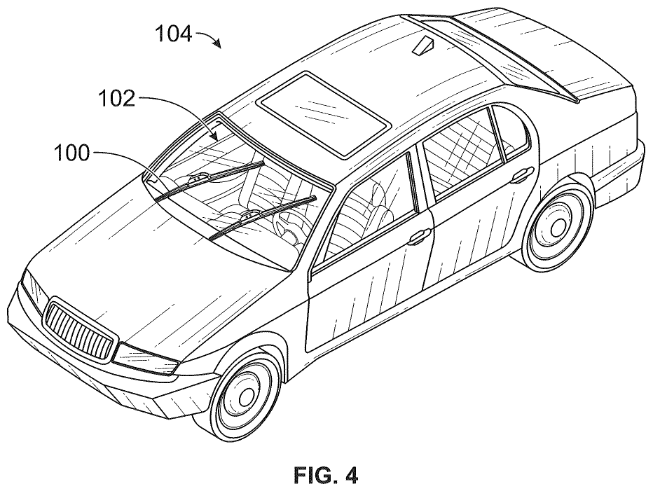

### DETAILED DESCRIPTION OF THE INVENTION

FIG. 4 illustrates a perspective view of a wiper blade assembly 100 in use with a vehicle 102 for cleaning a windshield 104. Though shown in use with an automobile 102, the wiper blade assembly 102 can be used on any vehicle 102 with windshield 104 or similar surface that requires cleaning, such as a truck, motorcycle, snow mobile, etc.

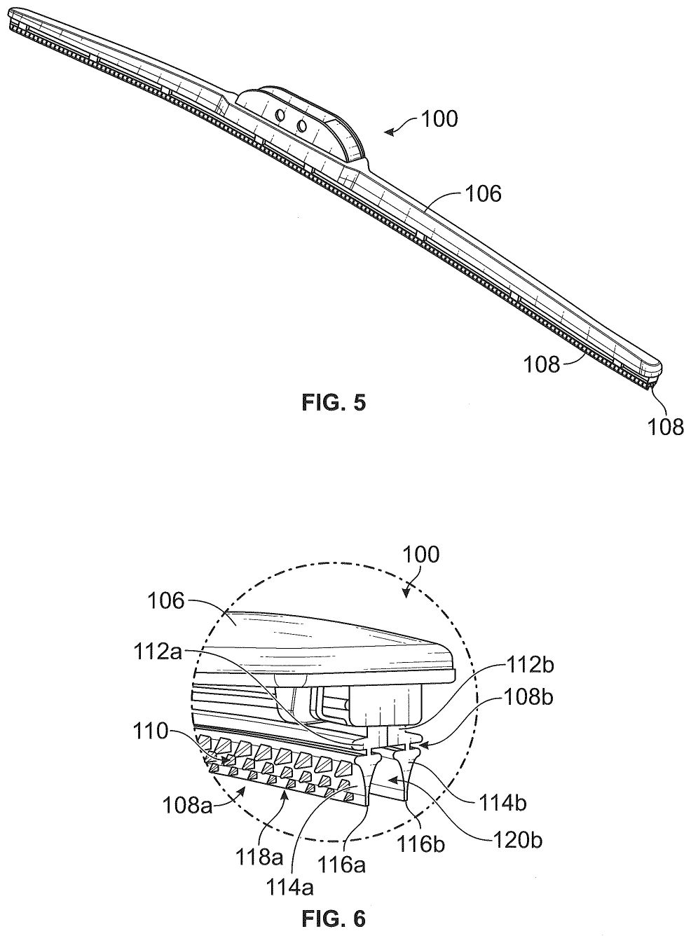

FIG. 5 illustrates an example of the wiper blade assembly 100 that includes a support 106 holding two wiper blades 108, each of which include a plurality of scrubbing elements 110. FIG. 6 illustrates a close-up view of the wiper blade assembly 100 shown in FIG. 5.

As shown in FIGS. 5 and 6, the wiper blade assembly 100 includes a first wiper blade 108a and a second wiper blade 108b held in a fixed relationship to each other by the support 106. Each of the wiper blades 108a and 108b comprises an elongated elastomeric body having an axial length spanning the length of the support 106. Each wiper blade 108a and 108b further includes a base 112a and 112b and a blade 114a and 114b projecting therefrom. The edge of each blade 114a and 114b that is furthest from the support 106 defines a blade edge 116a and 116b.

FIGS. 5 and 6 further show a first set of scrubbing elements 110 forming a first array located on the outer facing side surface 118a of the closer appearing blade 114a. Though not shown, a similar array of scrubbing elements 110 is present on the outer facing side surface of the further appearing blade 114b. As shown, the inner facing side surface 120b of the further appearing blade 114b does not include any scrubbing elements 110. Similarly, though not shown in FIGS. 5 and 6, the inner facing side surface of the closer appearing blade 114a does not include any scrubbing elements 110.

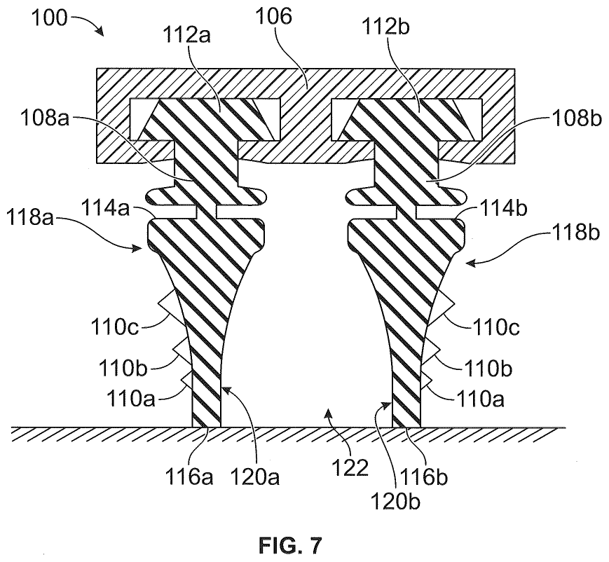

FIG. 7 illustrates a cross-sectional view of the wiper blade assembly of FIGS. 5 and 6. This view demonstrates the two wiper blades 108a and 108b are positioned by the support 106 such that they form a longitudinal channel 122 between the two wiper blades 108a and 108b. FIG. 7 further demonstrates the scrubbing elements 110 are found on the outer facing side surfaces 118a and 118b of the blades 114a and 114b and not on the inner facing side surfaces 120a and 120b (i.e., the side surfaces facing the channel 122).

In addition, FIG. 7 illustrates that the scrubbing elements 110 increase in height the further they are from the blade edges 116a and 116b. As shown in FIG. 7, the scrubbing elements 110a nearest the blade edges 116a and 116b are the shortest, the scrubbing elements 110b that are next further from the blade edges 116a and 116b are taller, and the scrubbing elements 110c furthest from the blade edges 116a and 116b are the tallest. In other words, the wiper blades 108a and 108b shown in FIGS. 7 include a first row 124a, a second row 124b, and a third row 124c of scrubbing elements 110. The first row 124a of scrubbing elements 110a has a first height H1 that is less than a second height H2 of the second row 124b of scrubbing elements 110b, and the second height H2 of the second row 124b of scrubbing elements 110b is less than a third height H3 of the third row 124c of scrubbing elements 110c. In the example shown in FIGS. 5-7, H1 is approximately 0.3 mm, H2 is approximately 0.45 mm, and H3 is approximately 0.55 mm.

In the example shown in FIGS. 5-7, the scrubbing elements 110 form an array that comprises three rows. However, it is contemplated the scrubbing elements 110 may form an array in any of a number of various patterns, including a greater or lesser number of rows, staggered positioning between the rows (such that the scrubbing elements 110 are not aligned along the vertical length of each blade 114a and 114b), etc.

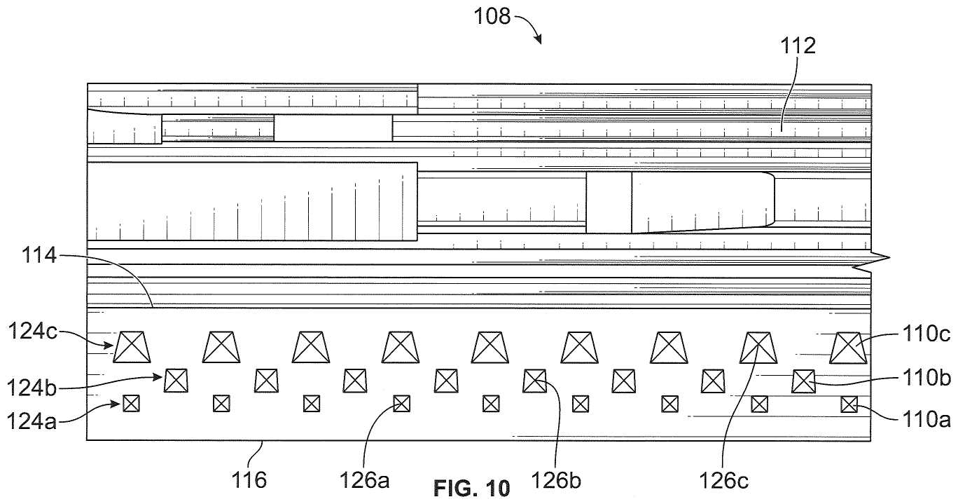

In addition, the scrubbing elements 110 shown in FIGS. 5-7 are three-dimensional pyramid shapes, with the scrubbing elements 110a in the first row 124a having square bases and the scrubbing elements 110b and 110c in the second row 124b and third row 124c having trapezoidal bases. The trapezoidal based scrubbing elements 110b and 110c further approximate a pyramid shape in which a tip 126b and 126c of the pyramid shape is offset from a center of the base away from the blade edge 116 and towards a side of the trapezoidal base furthest from the blade edge 116, whereas the square based scrubbing elements 110a are more symmetrical with a more centered tip 126a, which can further be seen in the array of scrubbing elements 110 shown in FIG. 10. In other embodiments, the base of the scrubbing elements 110 may be triangular, diamond, hexagonal, circular, etc. and may be a homogeneous or heterogeneous variety of shapes throughout the array.

The scrubbing elements 110 may be integrally molded with the blade 114 as shown in FIGS. 5-7. Alternatively, the scrubbing elements 110 may be inset molded within the blade 114. Alternatively, the scrubbing elements 110 may be attached to the blade 114 using an adhesive, a heat bonding technique, or similar attachment technique or process.

The wiper blades 108 and scrubbing elements 110 may be formed from any of a number of materials, such as natural rubber or silicone materials. They may be formed of the same material or from different materials. In other embodiments, the scrubbing elements may be formed from a synthetic or composite compound or halogen hardened natural compound to lengthen the life of the wiper blade 108 by reducing fatigue attributed to abrasion, temperature extremes, UV, ozone, acid rain and road salt, and any combinations thereof. Typical materials for fabricating the wiper blade 108 and/or the scrubbing elements 110 are: natural rubber; styrene butadiene rubber; synthetic polyisoprene rubber; isoprene-butadiene rubber; styrene-isoprene-butadiene rubber; silicone rubber compositions; polydioganosiloxanes; cis-1,4-polybutadiene rubber combined with other rubbery polymers, such as natural rubber, synthetic compounds or halogen hardened natural compounds. abrasion, temperature extremes, UV, ozone, acid rain and road salt, and any combinations thereof. The scrubbing elements 110 may be fabricated from materials with a higher modulus of elasticity such as polyimides, polyesters, nylon, polystyrene and any combinations thereof. In some application, even harder materials with very high modulus of elasticity and strength characteristics might be used to fabricate the scrubbing elements 110.

In addition, in some embodiments, the wiper blade 108 may be fabricated from a composite structure that combines a softer, more pliable material on a smooth surface (e.g., the inner facing side surfaces 120a and 120b in FIG. 7) for good wiping characteristics with a firmer, less pliable material for improved strength and durability on a surface that includes the scrubbing elements 110 (e.g., the outer facing side surfaces 118a and 118b in FIG. 7).

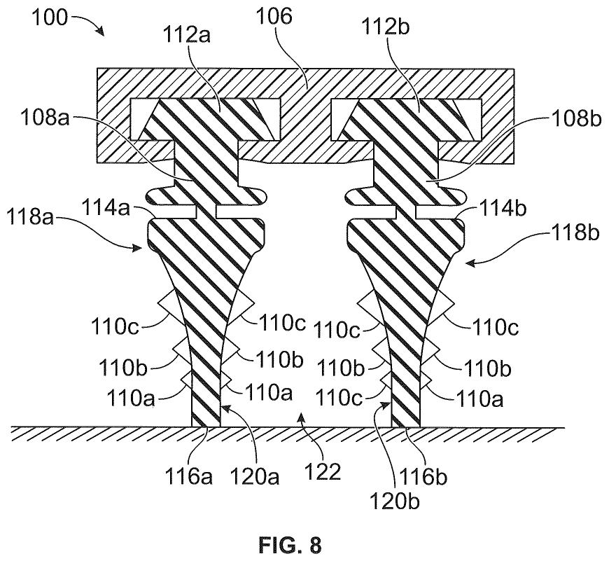

FIG. 8 illustrates a cross-sectional view of an alternative embodiment of a wiper blade assembly 100 in which both the inner facing side surfaces 120a and 120b and the outer facing side surfaces 118a and 118b including scrubbing elements 110.

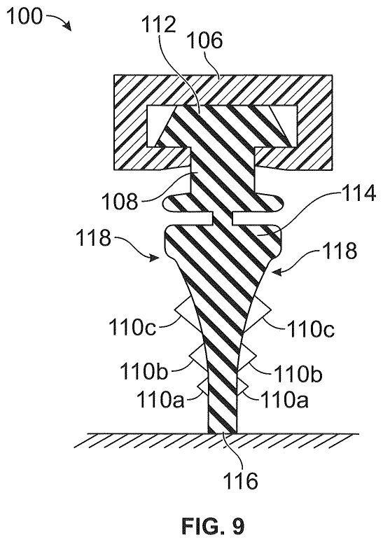

FIG. 9 is a cross-sectional view of another alternative embodiment of a wiper blade assembly 100 embodying a single wiper blade 108 in which both sides of the wiper blade 108 include scrubbing elements 110.

FIG. 10 is a side view of an example of a wiper blade assembly 100 using the scrubbing elements from the wiper blades in FIGS. 5-9. As shown, the scrubbing elements 110a in the first row 124a have square bases and the scrubbing elements 110b and 110c in the second row 124b and third row 124c having trapezoidal bases. The trapezoidal based scrubbing elements 110b and 110c further approximate a pyramid shape in which a tip 126 of the pyramid shape is offset from a center of the base away from the blade edge 116 and towards a side of the trapezoidal base furthest from the blade edge 116, whereas the square based scrubbing elements 110a are more symmetrical pyramid shapes.

In use, as the wiper blade assembly 100 passes along the windshield 104, the force of the vehicle's wiper arm pressing the blade 114 into the windshield 104, and the forces incurred from the resistance of the debris on the windshield 104, cause the blade 114 to deflect and deform away from the windshield 104. This deformation and deflection cause the portions of the blade 114 further from the blade edge 116 to be positioned further from the surface of the windshield 104 and at a steeper attack angle with respect to the surface of the windshield 104 than the portions of the blade 114 closer to the blade edge 116. The primary advantage of using an array of scrubbing elements 110 in which their heights increase as a function of their distance from the blade edge 116 is that the effective cleaning surface defined by the tips 126 of the scrubbing elements 110 are more likely to remain in contact with the surface of the windshield 104 at a preferred attack angle-typically within a range of approximately 30 degrees to 50 degrees. Accordingly, an array of scrubbing elements 100 in which each scrubbing element 100 is of an identical size may be less well-suited to remain in contact with the surface of the windshield 104 at the preferred attack angle.

It should be noted that various changes and modifications to the presently preferred embodiments described herein will be apparent to those skilled in the art. Such changes and modifications may be made without departing from the spirit and scope of the present invention and without diminishing its attendant advantages.

1. A wiper blade comprising:
an elongated elastomeric body having an axial length, the body including a base and a blade projecting from the base, wherein the blade includes a blade edge on the opposite side of the body from the base; and
a first set of scrubbing elements forming a first array located on a first side surface of the blade, wherein the first set of scrubbing elements includes a first plurality of scrubbing elements and a second plurality of scrubbing elements, wherein each of the first plurality of scrubbing elements is located closer to the blade edge as measured perpendicular to the axial length of the body than each of the second plurality of scrubbing elements, wherein each of the first plurality of scrubbing elements protrude a shorter height from the side surface of the blade than each of the second plurality of scrubbing elements.

2. The wiper blade of claim 1, wherein the first set of scrubbing elements further comprises a third plurality of scrubbing elements, wherein each of the second plurality of scrubbing elements is located closer to the blade edge as measured perpendicular to the axial length of the body than each of the third plurality of scrubbing elements, wherein each of the second plurality of scrubbing elements protrude a shorter height from the first side surface of the blade than each of the third plurality of scrubbing elements.

3. The wiper blade of claim 1, further comprising a second set of scrubbing elements forming a second array located on a second side surface of the blade, wherein each of a fourth plurality of scrubbing elements in the second set are located closer to the blade edge as measured perpendicular to the axial length of the body than a fifth plurality of scrubbing elements in the second set.

4. The wiper blade of claim 3, wherein the first set of scrubbing elements further comprises a third plurality of scrubbing elements, wherein each of the second plurality of scrubbing elements is located closer to the blade edge as measured perpendicular to the axial length of the body than each of the third plurality of scrubbing elements, wherein each of the second plurality of scrubbing elements protrude a shorter height from the first side surface of the blade than each of the third plurality of scrubbing elements; and
further wherein the second set of scrubbing elements further comprises a sixth plurality of scrubbing elements, wherein each of the fifth plurality of scrubbing elements is located closer to the blade edge as measured perpendicular to the axial length of the body than each of the sixth plurality of scrubbing elements, wherein each of the fifth plurality of scrubbing elements protrude a shorter height from the first side surface of the blade than each of the sixth plurality of scrubbing elements.

5. The wiper blade of claim 1, wherein the first plurality of scrubbing elements forms a first row along the axial length of the body and the second plurality of scrubbing elements forms a second row along the axial length of the body, wherein the first row is closer to the blade edge than the second row.

6. The wiper blade of claim 1, wherein each scrubbing element includes a substantially trapezoidal base.

7. The wiper blade of claim 1, wherein each scrubbing element includes a substantially square base.

8. The wiper blade of claim 1, wherein first set of scrubbing elements includes a plurality of scrubbing elements comprising a first three-dimensional shape and a plurality of scrubbing elements comprising a second three-dimensional shape.

9. The wiper blade of claim 5, wherein the first three-dimensional shape approximates a pyramid shape in which a tip of the pyramid is offset from a center of the base away from the blade edge and towards a side of the trapezoidal base furthest from the blade edge and the second three-dimensional shape approximates a symmetrical pyramid shape having a square base.

10. The wiper blade of claim 1, wherein the plurality of scrubbing elements are discreet scrubbing elements that are independent and non-continuous along an axial length of the blade.

11. The wiper blade of claim 1, wherein the scrubbing elements are integrally molded with the blade.

12. The wiper blade of claim 1, wherein the scrubbing elements are attached to the blade.

13. A wiper blade assembly comprising:
a first wiper blade and a second wiper blade, each comprising:
an elongated elastomeric body having an axial length, the body including a base and a blade projecting from the base, wherein the blade includes a blade edge on the opposite side of the body from the base;
a first set of scrubbing elements forming a first array located on a first side surface of the blade, wherein the first set of scrubbing elements includes a first plurality of scrubbing elements and a second plurality of scrubbing elements, wherein each of the first plurality of scrubbing elements is located closer to the blade edge as measured perpendicular to the axial length of the body than each of the second plurality of scrubbing elements, wherein each of the first plurality of scrubbing elements protrude a shorter height from the side surface of the blade than each of the second plurality of scrubbing elements; and
a support engaging the base of the first wiper blade and the base of the second wiper blade such that the support holds the first wiper blade and second wiper in a fixed position relative to each other forming a longitudinal channel between the first wiper blade and the second wiper blade.

14. The wiper blade assembly of claim 13, wherein the first side surface of the blade of the first wiper blade faces away from the second wiper blade and the first side surface of the blade of the second wiper blade faces away from the first wiper blade.

15. The wiper blade assembly of claim 14, wherein each of the first wiper blade and the second wiper blade further comprise a second side surface of the blade, wherein the second side surface of each of the first wiper blade and the second wiper blade is a substantially smooth surface.

16. The wiper blade assembly of claim 15, wherein the first plurality of scrubbing elements forms a first row along the axial length of the body and the second plurality of scrubbing elements forms a second row along the axial length of the body, wherein the first row is closer to the blade edge than the second row.

17. The wiper blade assembly of claim 16, wherein the plurality of scrubbing elements are discreet scrubbing elements that are independent and non-continuous along an axial length of the blade.

18. The wiper blade assembly of claim 17, wherein first set of scrubbing elements includes a plurality of scrubbing elements comprising a first three-dimensional shape and a plurality of scrubbing elements comprising a second three-dimensional shape, further wherein the first three-dimensional shape approximates a pyramid shape in which a tip of the pyramid is offset from a center of the base away from the blade edge and towards a side of the trapezoidal base furthest from the blade edge and the second three-dimensional shape approximates a symmetrical pyramid shape having a square base.
